(19) United States
(12) Patent Application Publication
(10) Pub. No.: US 2003/0022572 A1
(43) Pub. Date: Jan. 30, 2003

(54) Dry cleansing wipe with high foamability and efficient manufacture

(75) Inventors: Robert Edward Gott, Norwalk, CT (US); Craig Stephen Slavtcheff, Guilford, CT (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/835,701

(22) Filed: Apr. 16, 2001

(51) Int. Cl. B32B 5/02

(52) U.S. Cl. 442/93

(57) ABSTRACT

A disposable substantially dry cleansing article is disclosed having a cleansing composition impregnated onto a flexible substrate such as a non-woven cloth. The impregnated compositions include lathering surfactants and water in a relative weight ratio from about 1:2 to about 20:1, and having a viscosity ranging from about 70 to about 2.5 million cps. Speed of lather formation and foam volume increases within the window of the stated viscosity range.

### BACKGROUND OF THE INVENTION

1. Field of the Invention

The invention concerns low-cost, easily manufacturable disposable single use, substantially dry, cleansing articles.

2. The Related Art

Personal cleansing and conditioning products have traditionally been marketed in a variety of forms such as bar soaps, creams, lotions, and gels. These formulations have attempted to satisfy a number of criteria to be acceptable to consumers. These criteria include cleansing effectiveness, skin feel, skin mildness and lather volume. Ideal personal cleansers should gently cleanse the skin or hair, cause little or no irritation, and not leave the skin or hair overly dry after frequent use.

A series of granted and pending patent applications have been published by Procter & Gamble describing substantially dry, disposable, personal cleansing products which address many of the aforementioned functionality concerns. These products are substantially dry articles having deposited onto a woven or non-woven cloth a cleansing composition of surfactant, structurant, skin conditioning agent and other performance ingredients.

U.S. Pat. No. 5,951,991 (Wagner et al.) focuses on providing the substrate with a conditioning emulsion separately impregnated from the lathering surfactant onto the cloth substrate. U.S. Pat. No. 5,980,931 (Fowler et al.) emphasizes impregnation of oil soluble conditioning agents. WO 99/55303 (Albacarys et al.) describes skin care actives formulated with the cleansing composition.

Manufacturing processes for these products are reported in U.S. Pat. No. 5,952,043 and U.S. Pat. No. 5,863,663, both to Mackey et al. These patents teach use of a continuous lipid phase with a high melting waxy material deposited onto the wipe substrate. The material is intended to be sufficiently brittle so as to be easily disrupted by low shear contact (e.g. during wiping of the skin) to readily release an internal skin conditioning phase, yet the material is required to be sufficiently tough to avoid premature release of the internal phase during the rigors of processing. A problem with this technology is that through compromise the continuous external lipid phase/internal polar phase is neither sufficiently robust for processing and handling nor sufficiently releasable under wash conditions to allow efficient release of conditioning agent onto the skin.

Our evaluations of dry wipes produced by the Procter & Gamble technology has indicated poor latherability. We have attributed the problem to the relatively thick coating deposited onto the wipe substrate. A need exists for a dry cleansing wipe of improved foamability and one which can be efficiently manufactured.

Accordingly, it is an object of the present invention to provide a disposable, substantially dry cleansing product which upon contact with water rapidly lathers and generates a rich long lasting foam.

Another object of the present invention is to provide a disposable, substantially dry cleansing product having a cleansing composition coatable onto a flexible wiping cloth in a process that minimizes foam generation during manufacture.

Still another object of the present invention is to provide a disposable, substantially dry cleansing product which includes an impregnated composition allowing for improved manufacturability, better aesthetics and increased latherability.

These and other objects of the present invention will become more apparent in light of the following summary and disclosure.

### SUMMARY OF THE INVENTION

A substantially dry cleansing product is provided which includes:

(i) a water insoluble substrate; and

(ii) a cleansing composition impregnated onto the substrate including:

(a) at least one lathering surfactant;

(b) water; and

wherein a total of all lathering surfactants to water is present in a weight ratio from about 1:2 to about 20:1, and the composition having a viscosity as measured on a Haake CV 20 Rheometer with 30 mm profiled parallel plates at 23° C. ranging from about 70 to about 2,500,000 cps.

### DETAILED DESCRIPTION OF THE INVENTION

Now it has been discovered that there is a critical range of viscosity for the impregnated cleansing composition. Below a minimum viscosity, the composition foams poorly when the dry wipe is wetted with water by a consumer. The thinness of the composition is readily washed away by water down the sink and unavailable for lathering. By contrast, a too high viscosity composition cannot be quickly activated with water for lathering by a consumer. There is a delay period. Another important discovery has been the relative weight relationship between surfactant and water.

Accordingly, the compositions of the present invention will have a viscosity ranging from about 70 to about 2,500,000 cps.

Thickness is measured on a Haake CV 20 Rheometer with 30 mm profiled parallel plates at 23° C. A preferred viscosity range is from about 100 to about 2,000,000 cps, optimally from about 150 to about 200,000, even more preferably from about 200 to about 5,000 cps.

Advantageously small amounts of water may be present in the impregnated compositions. These amounts should not exceed 20% but may range from about 0.1 to about 15%, and usually from about 1 to about 4% by weight.

An essential element of compositions according to the present invention is that of a lathering surfactant. By a “lathering surfactant” is meant a surfactant, which when combined with water and mechanically agitated generates a foam or lather.

Preferably, these lathering surfactants should be mild, which means that they must provide sufficient cleansing or detersive benefits but not overly dry the skin or hair, and yet meet the lathering criteria described above.

The products of the present invention typically include at least one lathering surfactant in an amount from about 0.5% to about 60%, preferably from about 0.75% to about 40%, and more preferably from about 1% to about 20%, based on the weight of the impregnated composition.

A wide variety of lathering surfactants are useful herein and include those selected from the group consisting of anionic, nonionic, cationic, amphoteric and lathering surfactant mixtures thereof.

Among the anionic lathering surfactants useful herein are the following non-limiting examples which include the classes of:

(1) Alkyl benzene sulfonates in which the alkyl group contains from 9 to 15 carbon atoms, preferably 11 to 14 carbon atoms in straight chain or branched chain configuration. Especially preferred is a linear alkyl benzene sulfonate containing about 12 carbon atoms in the alkyl chain.

(2) Alkyl sulfates obtained by sulfating an alcohol having 8 to 22 carbon atoms, preferably 12 to 16 carbon atoms. The alkyl sulfates have the formula ROSO₃₋M⁺ where R is the C₈₋₂₂ alkyl group and M is a mono- and/or divalent cation.

(3) Paraffin sulfonates having 8 to 22 carbon atoms, preferably 12 to 16 carbon atoms, in the alkyl moiety. These surfactants are commercially available as Hostapur SAS from Hoechst Celanese.

(4) Olefin sulfonates having 8 to 22 carbon atoms, preferably 12 to 16 carbon atoms. Most preferred is sodium C₁₄-C₁₆ olefin sulfonate, available as Bioterge AS 40®

(5) Alkyl ether sulfates derived from an alcohol having 8 to 22 carbon atoms, preferably 12 to 16 carbon atoms, ethoxylated with less than 30, preferably less than 12, moles of ethylene oxide. Most preferred is sodium lauryl ether sulfate formed from 2 moles average ethoxylation, commercially available as Standopol ES-2®.

(6) Alkyl glyceryl ether sulfonates having 8 to 22 carbon atoms, preferably 12 to 16 carbon atoms, in the alkyl moiety.

(7) Fatty acid ester sulfonates of the formula: R¹CH(SO₃₋M+)CO₂R² where R¹ is straight or branched alkyl from about C₈- to C₁₈, preferably C₁₂ to C₁₆, and R² is straight or branched alkyl from about C₁ to C₆, preferably primarily C₁, and M+ represents a mono- or divalent cation.

(8) Secondary alcohol sulfates having 6 to 18, preferably 8 to 16 carbon atoms.

(9) Fatty acyl isethionates having from 10 to 22 carbon atoms, with sodium cocoyl isethionate being preferred.

(10) Dialkyl sulfosuccinates wherein the alkyl groups range from 3 to 20 carbon atoms each.

(11) Alkanoyl sarcosinates corresponding to the formula RCON(CH₃)CH₂CH₂CO₂M wherein R is alkyl or alkenyl of about 10 to about 20 carbon atoms and M is a water-soluble cation such as ammonium, sodium, potassium and trialkanolammonium. Most preferred is sodium lauroyl sarcosinate.

(12) Alkyl lactylates wherein the alkyl groups range from 8 to 12 carbon atoms, with sodium lauroyl lactylate sold as Pationic 138C® available from the Patterson Chemical Company as the most preferred.

(13) Taurates having from 8 to 16 carbon atoms, with cocoyl methyl taurate being preferred.

Nonionic lathering surfactants suitable for the present invention include C₁₀-C₂₀ fatty alcohol or acid hydrophobes condensed with from 2 to 100 moles of ethylene oxide or propylene oxide per mole of hydrophobe; C₂-C₁₀ alkyl phenols condensed with from 2 to 20 moles of alkylene oxides; mono- and di- fatty acid esters of ethylene glycol such as ethylene glycol distearate; fatty acid monoglycerides; sorbitan mono- and di-C₈-C₂₀ fatty acids; and polyoxyethylene sorbitan available as Polysorbate 80 and Tween 80® as well as combinations of any of the above surfactants.

Other useful nonionic surfactants include alkyl polyglycosides, saccharide fatty amides (e.g. methyl gluconamides) as well as long chain tertiary amine oxides. Examples of the latter category are: dimethylododecylamine oxide, oleyldi(2-hydroxyethyl)amine oxide, dimethyloctylamine oxide, dimethyldecylamine oxide, dimethyltetradecylamine oxide, di(2-ydroxyethyl)tetradecylamine oxide, 3-didodecyloxy-2-hydroxypropyldi(3-hydroxypropyl)amine oxide, and dimethylhexadecylamine oxide.

Amphoteric lathering surfactants useful for the present invention include aliphatic secondary and tertiary amines, preferably wherein the nitrogen is in a cationic state, in which the aliphatic radicals can be straight or branched chain and wherein one of the radicals contains an ionizable water solubilizing group such as carboxy, sulphonate, sulphate, phosphate or phosphonate. Illustrative substances are cocamidopropyl betaine, cocamphoacetate, cocamphodiacetate, cocamphopropionate, cocamphodipropionate, cocamidopropyl hydroxysultaine, cetyl dimethyl betaine, cocamidopropyl PG-dimonium chloride phosphate, coco dimethyl carboxymethyl betaine, cetyl dimethyl betaine and combinations thereof.

A further essential element of the present invention is that the total of all lathering surfactants to water weight ratio range from about 1:2 to about 20:1, preferably from about 1:1 to about 8:1, more preferably from about 2:1 to about 5:1.

A necessary element of the present invention is that of a water insoluble substrate. By “water insoluble” is meant the substrate does not dissolve or readily break apart upon immersion in water.

A wide variety of materials can be used as the substrate. The following non-limiting characteristics are desirable: (i) sufficient wet strength for use, (ii) sufficient abrasivity, (iii) sufficient loft and porosity, (iv) sufficient thickness, and (v) appropriate size.

Non-limiting examples of suitable insoluble substrates which meet the above criteria include non-woven substrates, woven substrates, hydro-entangled substrates, air entangled substrates and the like. Preferred embodiments employ non-woven substrates since they are economical and readily available in a variety of materials. By non-woven is meant that the layer is comprised of fibers which are not woven into a fabric but rather are formed into a sheet, particularly a tissue. The fibers can either be random (i.e., randomly aligned) or they can be carded (i.e. combed to be oriented in primarily one direction). Furthermore, the non-woven substrate can be composed of a combination of layers of random and carded fibers.

Non-woven substrates may be comprised of a variety of materials both natural and synthetic. By natural is meant that the materials are derived from plants, animals, insects or byproducts. By synthetic is meant that the materials are obtained primarily from various man-made materials or from material that is usually a fibrous web comprising any of the common synthetic or natural textile-length fibers, or mixtures thereof.

Non-limiting examples of natural materials useful in the present invention are silk fibers, keratin fibers and cellulosic fibers. Non-limiting examples of keratin fibers include those selected from the group consisting of wool fibers, camel hair fibers, and the like. Non-limiting examples of cellulosic fibers include those selected from the group consisting of wood pulp fibers, cotton fibers, hemp fibers, jute fibers, flax fibers, and mixtures thereof.

Non-limiting examples of synthetic materials useful in the present invention include those selected from the group consisting of acetate fibers, acrylic fibers, cellulose ester fibers, modacrylic fibers, polyamide fibers, polyester fibers, polyolefin fibers, polyvinyl alcohol fibers, rayon fibers and mixtures thereof. Examples of some of these synthetic materials include acrylics such as Acrilan®, Creslan®, and the acrylonitrile-based fiber, Orlon®; cellulose ester fibers such as cellulose acetate, Arnel®, and Acele®; polyamides such as Nylons (e.g., Nylon 6, Nylon 66, and Nylon 610); polyesters such as Fortrel®, Kodel®, and Dacron®; polyolefins such as polypropylene, polyethylene; polyvinyl acetate fibers and mixtures thereof.

Non-woven substrates made from natural materials consist of webs or sheets most commonly formed on a fine wire screen from a liquid suspension of the fibers.

Substrates made from natural materials useful in the present invention can be obtained from a wide variety of commercial sources. Non-limiting examples of suitable commercially available paper layers useful herein include Airtex®, an embossed airlaid cellulosic layer having a base weight of about 71 gsy, available from James River Corporation, Green Bay, Wis.; and Walkisoft®, an embossed airlaid cellulosic having a base weight of about 75 gsy, available from Walkisoft U.S.A., Mount Holly, N.C.

Non-woven substrates made from synthetic material useful in the present invention can also be obtained form a wide variety of commercial sources. Non-limiting examples of suitable non-woven layer materials useful herein include HFE-40-047, an apertured hydroentangled material containing about 50% rayon and 50% polyester, and having a basis weight of about 43 grams per square yard (gsy), available from Vertec, Inc., Walpole, Mass.; HEF 140-102, an apertured hydro-entangled material containing about 50% rayon and 50% polyester, and having a basis weight of about 56 gsy, available from Veratec, Inc., Walpole, Mass.; Novenet® 149-191, a thermo-bonded grid patterned material containing about 69% rayon, about 25% polypropylene, and about 6% cotton, and having a basis weight of about 100 gsy, available from Veratec, Inc., Walpole, Mass.; HEF Nubtex® 149-801, a nubbed, apertured hydro-entangled material, containing about 100% polyester, and having a basis weight of about 70 gsy, available from Veratec, Inc. Walpole, Mass.; Keybak® 951V, a dry formed apertured material, containing about 75% rayon, about 25% acrylic fibers, and having a basis weight of about 43 gsy, available from Chicopee Corporation, New Brunswick, N.J.; Keybak® 1368, an apertured material, containing about 75% rayon, about 5% polyester, and having a basis weight of about 39 gsy, available from Chicopee Corporation, New Brunswick, N.J.; Duralace® 1236, an apertured, hydro-entangled material, containing about 100% rayon, and having a basis weight from about 40 gsy to about 115 gsy, available from Chicopee Corporation, New Brunswick, N.J.; Duralace® 5904, an apertured, hydro-entangled material, containing about 100% polyester, and having a basis weight from about 40 gsy to about 115 gsy, available from Chicopee Corporation, New Brunswick, N.J.; Sontaro® 8868, a hydro-entangled material, containing about 50% cellulose and about 50% polyester, and having a basis weight of about 60 gsy, available from Dupont Chemical Corp.

Most preferred as a substrate for purposes of this invention are non-woven substrates, especially blends of rayon/polyester and ratios of 10:90 to 90:10, preferably ratios of 20:80 to 80:20, optimally 40:60 to 60:40 by weight. A most useful substrate is a 70:30 rayon/polyester non-woven wipe article.

Anywhere from 1 to 100, preferably from 5 to 50 single wipes may be stored within a dispensing pouch or container, preferably a moisture impermeable pouch or container. During storage and between dispensing, the pouch or container is preferably resealable. Single wipe containing pouches may also be employed.

The water insoluble substrates of the present invention can comprise two or more layers, each having a different texture and abrasiveness. The differing textures can result from the use of different combinations of materials or from the use of a substrate having a more abrasive side for exfoliation and a softer, absorbent side for gentle cleansing. In addition, separate layers of the substrate can be manufactured to have different colors, thereby helping the user to further distinguish the surfaces.

The amount of impregnating composition relative to the substrate may range from about 20:1 to 1:20, preferably from 10:1 to about 1:10 and optimally from about 2:1 to about 1:2 by weight.

Impregnating compositions of the present invention may also include silicones of a volatile and non-volatile variety. Typical volatile silicones are the cyclomethicones commercially available as Dow Corning 244, 245, 344 and 345. Linear volatile dimethicones are also suitable. Non-volatile silicones include polydimethyl siloxanes of a viscosity greater than 2 centistoke and silicone copolyols also known as dimethicone copolyol for which Dow Corning 193 is a commercial source. Amounts of the silicones may range from about 0.01 to about 20, preferably from about 0.5 to about 3% by weight of the impregnated composition.

Cationic conditioning agents in monomeric and polymeric type are also useful for purposes of this invention. Examples of the polymeric type include: cationic cellulose derivatives, cationic starches, copolymers of a diallyl quaternary ammonium salt and an acryl amide, quaternized vinylpyrrolidone vinylimidazole polymers polyglycol amine condensates, quaternized collagen polypeptide, polyethylene imine, cationized silicon polymer (e.g. Amodimethicone), cationic silicon polymers provided in a mixture with other components under the trademark Dow Corning 929 (cationized emulsion), copolymers of adipic acid and dimethylaminohydroxypropyl diethylenetriamine, cationic chitin derivatives, cationized guar gum (e.g. Jaguar C-B-S, Jaguar C-17, Jaguar C-16 etc. manufactured by the Celanese Company), quaternary ammonium salt polymers (e.g. Mirapol A-15, Mirapol AD-1, Mirapol AZ-1, etc., manufactured by the Miranol Division of the Rhone Poulenc Company). Most preferred is polyquaternium-11 available as Luviquat® PQ 11 sold by the BASF Corporation.

Examples of monomeric cationic conditioning agents are salts of the general structure:

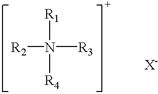

wherein R¹ is selected from an alkyl group having from 12 to 22 carbon atoms, or aromatic, aryl or alkaryl groups having from 12 to 22 carbon atoms; R², R³, and R⁴ are independently selected from hydrogen, an alkyl group having from 1 to 22 carbon atoms, or aromatic, aryl or alkaryl groups having from 12 to 22 carbon atoms; and X⁻ is an anion selected from chloride, bromide, iodide, acetate, phosphate, nitrate, sulfate, methyl sulfate, ethyl sulfate, tosylate, lactylate, citrate, glycolate, and mixtures thereof. Additionally, the alkyl groups can also contain ether linkages, or hydroxy or amino group substituents (e.g. the alkyl groups can contain polyethylene glycol and polypropylene glycol moieties). Preferably the anion is phosphate, especially preferred is hydroxy ethyl cetyl dimonium phosphate available as Luviquat® Mono CP from the BASF Corporation.

Amino silicones quats may similarly be employed. Most preferred is Silquat AD designated by the CTFA as Silicone Quaternium 8, available from Siltech Inc.

Amounts of each cationic agent may range from about 0.06 to about 5%, preferably from 0.1 to 3%, optimally from 0.3 to 2.5% by weight of the impregnated composition.

Moisturizing conditioners may also be included in compositions of the present invention. Water soluble moisturizers such as polyhydric alcohols are particularly preferred. Typical polyhydric alcohols include glycerol (also known as glycerin), polyalkylene glycols and more preferably alkylene polyols and their derivatives, including propylene glycol, dipropylene glycol, polypropylene glycol, polyethylene glycol and derivatives thereof, sorbitol, hydroxypropyl sorbitol, hexylene glycol, 1,3-butylene glycol, 1,2,6-hexanetriol, ethoxylated glycerol, propoxylated glycerol and mixtures thereof. For best results the water-soluble conditioner is preferably glycerin. Also particularly preferred are polyethylene glycol (average molecular weight ranging from about 200 to about 2,000,000, with PEG-100 and PEG-14M being preferred) and hexylene glycol. In certain types of composition the latter conditioner may be inappropriate and therefore polyols other than hexylene glycol should be utilized. The amount of water-soluble conditioners may range anywhere from about 0.5 to about 40%, preferably between about 1 and about 20% by weight of the composition.

The disposable, single use personal care cleansing products of the present invention are manufactured by separately or simultaneously adding onto or impregnating into a water insoluble substrate the cleansing composition including lathering surfactants and conditioners, wherein the resulting product is substantially dry. By “separately” is meant that the surfactants and the conditioners can be added sequentially, in any order without first being combined together. By “simultaneously” is meant that the surfactants and conditioners can be added at the same time, with or without first being combined together.

The surfactant, conditioner and any optional ingredients can be added onto or impregnated into the water insoluble substrate by any means known to those skilled in the art. For example, addition can be through spraying, laser printing, splashing, dipping, soaking, or coating.

When water or moisture is used or present in the manufacturing process, the resulting treated substrate is then dried so that it is substantially free of water. The treated substrate can be dried by any means known to those skilled in the art. Non-limiting examples of known drying means include the use of convection ovens, radiant heat sources, microwave ovens, forced air ovens, and heated rollers or cams. Drying also includes air drying without the addition of heat energy, other than that present in the ambient environment. Also, a combination of various drying methods can be used.

Except in the operating and comparative examples, or where otherwise explicitly indicated, all numbers in this description indicating amounts of material ought to be understood as modified by the word “about”.

The term “comprising” is meant not to be limiting to any subsequently stated elements but rather to encompass non-specified elements of major or minor functional importance. In other words the listed steps, elements or options need not be exhaustive.

The following examples will more fully illustrate the embodiments of this invention. All parts, percentages and proportions referred to herein and in the appended claims are by weight unless otherwise illustrated.

### EXAMPLE 1

A set of comparative experiments were conducted to evaluate the effect of viscosity on latherability and resultant foam volume on a dry wipe. Table I lists components and concentrations for comparative Samples A-C.

TABLE I

| | SAMPLE (WEIGHT %) | | |
|---|---|---|---|
| INGREDIENT | A | B | C |
| Hexylene Glycol | 30.0 | 41.74 | 36.36 |
| Water | 30.0 | 2.61 | 15.5 |
| Hamposyl L-95 ® (sodium lauroyl | 20.0 | 27.83 | 24.24 |
| sarcosinate, 94% active) | | | |
| Tegobetaine CKD ® (cocamidopropyl | 20.0 | 27.83 | 24.24 |
| betaine, 83% active) | | | |
| VISCOSITY* (cps) | 50 | 2,900,000 | 400 |

* Measured using a Haake CV 20 Rheometer with 30 mm profile panel plates at 23° C.

Polyester/rayon towelettes weighing 2.0 grams were coated with the Sample compositions. These were spread evenly over the 6 inch by 7.5 inch area of the towelette substrate. Coating weights for Samples A, B and C were respectively 0.8, 0.57 and 0.65 grams. These coating weights left on each Sample towelette a deposit of 0.24 grams hexylene glycol, 0.16 grams Hamposyl L-95® and 0.16 grams of Tegobetaine CKD®.

The dry towelette coated Samples A-C were then evaluated for their foaming properties. Ten panelists were employed in the evaluation. Each towelette was wetted by the panelists with warm water. They were instructed to dispense water evenly over the towelette. Thereafter, the towelette was crumpled and rubbed to generate lather. Evaluations were done for lather speed (flash lather) and amount. Table II reports results of those evaluations.

TABLE II

| | Towelette Sample* | | | | | |
|---|---|---|---|---|---|---|
| | A | | B | | C | |
| | Lather | Lather | Lather | Lather | Lather | Lather |
| | Speed | Amount | Speed | Amount | Speed | Amount |
| Panelist 1 | 4 | 3 | 3 | 3 | 4 | 4 |
| Panelist 2 | 5 | 5 | 3 | 4 | 5 | 5 |
| Panelist 3 | 4 | 3 | 3 | 3 | 5 | 4 |
| Panelist 4 | 3 | 2 | 2 | 2 | 4 | 4 |
| Panelist 5 | 4 | 2 | 2 | 4 | 5 | 5 |
| Panelist 6 | 4 | 3 | 3 | 3 | 5 | 5 |
| Panelist 7 | 4 | 4 | 3 | 4 | 4 | 5 |
| Panelist 8 | 4 | 2 | 2 | 3 | 4 | 4 |
| Panelist 9 | 3 | 3 | 3 | 3 | 4 | 5 |
| Panelist 10 | 4 | 3 | 2 | 3 | 4 | 4 |
| Average | 3.8 | 2.9 | 2.6 | 3.2 | 4.4 | 4.5 |

*Rating of 1 = slow lather formation/little amount.
Rating of 5 = fast lather formation/copious amount.

Samples A-C compositions were formulated so that 3 of the 4 components (hexylene glycol, cocamidopropyl betaine and sodium lauroyl sarcosinate) were held at constant relative concentrations. Water levels were varied to obtain the different viscosities.

Sample A towelette was loaded with an extremely thin composition. The average lather speed and lather amount were significantly poorer than those generated with the Sample C towelette (representing the present invention). Sample B represented a very high viscosity almost wax-like coating. Lather speed and amount were significantly less than with the Sample C coated towelette. These results indicate that coatings of too high or too low viscosities impair foaming properties.

### EXAMPLE 2

A series of compositions are presented under Table III reflective of the present invention.

TABLE III

| | SAMPLE (WEIGHT %) | | | | | | |
|---|---|---|---|---|---|---|---|
| INGREDIENT | A | B | C | D | E | F | G |
| Hexylene Glycol | 16.00 | 14.00 | 12.00 | — | 20.00 | 20.00 | |
| Butylene Glycol | — | — | — | 16.00 | | — | 20.00 |
| Water | — | — | — | — | — | 20.00 | 20.00 |
| Polyquaternium 7 (Merquat | 1.33 | 1.33 | 1.33 | 1.33 | — | — | — |
| 2200 ®) | | | | | | | |
| Cocamidopropyl Betaine | 17.60 | 17.60 | 17.60 | 17.60 | 20.00 | 30.00 | 30.00 |
| (Tegobetaine CKD ®; | | | | | | | |
| (82% Active) | | | | | | | |
| Decyl Polyglucoside (Plantaren | 36.00 | 38.00 | 40.00 | 36.00 | 40.00 | — | — |
| 2000N ®; 50% Active in | | | | | | | |
| Water) | | | | | | | |
| Sodium Lauroyl Sarcosinate | 17.60 | 17.60 | 17.60 | 17.60 | 20.00 | 30.00 | 30.00 |
| (Hamposyl L-95 ®; 94% | | | | | | | |
| Active) | | | | | | | |
| Sodium Lauroyl Lactylate | 1.74 | 1.74 | 1.74 | 1.74 | — | — | — |
| (Pationic 138C ®) | | | | | | | |
| Capric/Caprylic Triglycerides | 2.50 | 2.50 | 2.50 | 2.50 | — | — | — |
| (Miglyol 812 ®) | | | | | | | |
| Silicone Quaternium-8 (Silquat | 6.00 | 6.00 | 6.00 | 6.00 | — | — | — |
| AD ®; 40% Active in Water) | | | | | | | |
| Fragrance | 1.03 | 1.03 | 1.03 | 1.03 | — | — | — |
| Glydant Plus ® Liquid (DMDM | 0.20 | 0.20 | 0.20 | 0.20 | — | — | — |
| Hydantoin and Iodopropynyl | | | | | | | |
| Butylcarbamate in Butylene | | | | | | | |
| Glycol) | | | | | | | |

| | SAMPLE (WEIGHT %) | | | | | | |
|---|---|---|---|---|---|---|---|
| INGREDIENT | H | I | J | K | L | M | N |
| Hexylene Glycol | — | 23.50 | 15.00 | 19.3 | — | — | — |
| Butylene Glycol | — | — | — | — | — | 34.3 | — |
| Glycerin | — | — | — | — | 30.00 | — | — |
| Ammonium Xylene Sulfonate (Stepanate ® | 20.00 | — | — | — | — | — | 33.30 |
| AXS) | | | | | | | |
| Water | — | — | — | 20.00 | — | — | — |
| Sodium Laureth Sulfate, 2 mol, 70% in water | — | 40.00 | — | — | 28.00 | 40.00 | 40.00 |
| (Steol ® CS 270) | | | | | | | |
| Polyquaternium 7 (Merquat 2200 ®) | — | 1.00 | — | 1.00 | — | — | 1.00 |
| Cocamidopropyl Betaine (Tegobetaine CKD ®; | 16.125 | 30.00 | 14.07 | 27.00 | 18.00 | 15.00 | 20.0 |
| 82% Active) | | | | | | | |
| Decyl Polyglucoside (Plantaren 2000N ®; 50% | 34.00 | — | 28.15 | — | 18.00 | — | — |
| Active in Water) | | | | | | | |
| Sodium Lauroyl Sarcosinate (Hamposyl L- | 16.13 | — | 14.08 | 27.00 | — | — | — |
| 95 ®; 94% Active) | | | | | | | |
| Sodium Lauroyl Lactylate (Pationic 138C ®) | 2.00 | — | — | — | — | — | — |
| Capric/Caprylic Triglycerides (Miglyol 812 ®) | 5.00 | 5.00 | 5.00 | 5.00 | 3.00 | — | — |
| Dimethicone (D/C 200 fluid) | — | — | | — | — | 10.00 | — |
| Sunflowerseed oil (Cropure Sunflower) | — | — | 20.00 | — | — | — | 5.00 |
| Petrolatum | — | — | 3.0 | — | 2.50 | — | — |
| Silicone Quaternium-8 (Silquat AD ®; 40% | 6.00 | — | — | — | — | — | |
| Active in Water) | | | | | | | |
| Fragrance | 0.50 | 0.50 | 0.50 | 0.50 | 0.50 | 0.50 | 0.50 |
| Glydant Plus ® Liquid (DMDM Hydantoin and | 0.25 | — | 0.20 | 0.20 | — | 0.20 | 0.20 |
| Iodopropynyl Butylcarbamate in Butylene | | | | | | | |
| Glycol) | | | | | | | |

| | SAMPLE (WEIGHT %) | | | | |
|---|---|---|---|---|---|
| INGREDIENT | O | P | Q | R | S |
| Hexylene Glycol | 15.50 | 19.30 | — | — | — |
| Butylene Glycol | — | — | — | — | — |
| Glycerin | — | — | 19.30 | — | — |
| Ammonium Xylene Sulfonate (Stepanate ® | — | — | — | 19.30 | 19.30 |
| AXS) | | | | | |
| Water | — | — | — | — | — |
| Sodium Laureth Sulfate, 2 mol, 70% in water | — | 35.00 | 35.00 | 35.00 | 35.00 |
| (Steol CS ® 270) | | | | | |
| Polyquaternium 10 (Polymer JR ® 400) | 2.00 | 1.00 | — | — | 1.00 |
| Polyquaternium 7 (Merquat 2200 ®) | — | — | 1.00 | 1.00 | — |
| Cocamidopropyl Betaine (Tegobetaine CKD ®; | 18.00 | — | 18.00 | 18.00 | — |
| 82% Active) | | | | | |
| Decyl Polyglucoside (Plantaren 2000N ®; 50% | 36.00 | 40.00 | 40.00 | 40.00 | 40.00 |
| Active in Water) | | | | | |
| Sodium Lauroyl Sarcosinate (Hamposyl L- | 18.00 | — | — | — | — |
| 95 ®; 94% Active) | | | | | |
| Sodium Lauroyl Lactylate (Pationic 138C ®) | 1.00 | — | — | — | — |
| Capric/Caprylic Triglycerides (Miglyol 812 ®) | 3.00 | — | — | — | — |
| Dimethicone (D/C 200 fluid) | — | — | — | — | — |
| Sunflowerseed oil (Cropure Sunflower) | — | 3.00 | 3.00 | 3.00 | 3.00 |
| Petrolatum | — | 1.00 | 1.00 | 1.00 | 1.00 |
| Silicone Quaternium-8 (Silquat AD ®; 40% | 6.00 | — | — | — | — |
| Active in Water) | | | | | |
| Fragrance | 0.30 | 0.50 | 0.50 | 0.50 | 0.50 |
| Glydant Plus ® Liquid (DMDM Hydantoin and | 0.20 | 0.20 | 0.20 | 0.20 | 0.20 |
| Iodopropynyl Butylcarbamate in Butylene | | | | | |
| Glycol) | | | | | |

The foregoing description and examples illustrate selected embodiments of the present invention. In light thereof variations and modifications will be suggested to one skilled in the art, all of which are within the spirit and purview of this invention.

What is claimed is:

1. A substantially dry cleansing product comprising:
(i) a water insoluble substrate; and
(ii) a cleansing composition impregnated onto the substrate comprising:
(a) at least one lathering surfactant;
(b) water; and
wherein a total of all lathering surfactants to water is present in a weight ratio from about 1:2 to about 20:1, and the composition having a viscosity as measured on a Haake CV 20 Rheometer with 30 mm profiled parallel plates at 23° C. ranging from about 70 to about 2,500,000 cps.

2. The product according to claim 1 wherein the viscosity ranges from about 100 to about 2,000,000 cps.

3. The product according to claim 1 wherein the viscosity ranges from about 150 to about 200,000 cps.

4. The product according to claim 1 wherein the viscosity ranges from about 200 to about 5,000 cps.

5. The product according to claim 1 wherein the weight ratio of surfactants to water ranges from about 1:1 to about 8:1.

6. The product according to claim 1 wherein the at least one lathering surfactant is present in an amount from about 0.5 to about 60% by weight of total impregnated composition deposited upon the water insoluble substrate.

7. The article according to claim 1 wherein the water insoluble substrate is a sheet selected from a group consisting of non-woven, woven, hydro-entangled and air entangled substrates.

8. A substantially dry cleansing product comprising:
(i) a water insoluble substrate; and
(ii) a cleansing composition impregnated onto the substrate comprising:
(a) at least one lathering surfactant;
(b) water; and
wherein a total of all lathering surfactants to water is present in a weight ratio from about 1:1 to about 8:1, and the composition having a viscosity as measured on a Haake CV 20 Rheometer with 30 mm profiled parallel plates at 23° C. ranging from about 100 to about 2,000,000 cps.

9. A substantially dry cleansing product comprising:
(i) a water insoluble substrate; and
(ii) a cleansing composition impregnated onto the substrate comprising:
(a) at least one lathering surfactant;
(b) water; and
wherein a total of all the lathering surfactants to water is present in a weight ratio from about 2:1 to about 5:1, and the composition having a viscosity as measured on a Haake CV 20 Rheometer with 30 mm profiled parallel plates at 23° C.
